(19) United States
(12) Patent Application Publication
(10) Pub. No.: US 2013/0050189 A1
(43) Pub. Date: Feb. 28, 2013

(54) Method for Data Security and Device Thereof

(71) Applicants: Tien-Chung Tseng, New Taipei City (TW); Chun-Ming Wu, New Taipei City (TW)

(72) Inventors: Tien-Chung Tseng, New Taipei City (TW); Chun-Ming Wu, New Taipei City (TW)

(21) Appl. No.: 13/295,101

(22) Filed: Nov. 14, 2011

(30) Foreign Application Priority Data
Aug. 30, 2011 (TW) 100131069

(51) Int. Cl. G06T 15/00; G02B 27/22

(52) U.S. Cl. 345/419; 359/464

(57) ABSTRACT

A method for data security for shutter glasses includes receiving a frame data outputted from a display device, wherein the frame data includes a security data arranged in the frame data according to an encoding rule, and switching back and forth between an on state and an off state according to the encoding rule, to retrieve the security data from the frame data.

### BACKGROUND OF THE INVENTION

1. Field of the Invention

The present invention relates to a method for data security and device thereof, and more particularly, to a method for data security and device thereof for preventing displayed data from peeking, so as to enhance data security.

2. Description of the Prior Art

In the public area, such as a conference room, coffee shop, waiting room, ATM etc., some display data is unwilling to be seen by surrounding people, for example, around an operational environment of an ATM, a person may intent to peek displayed data on the a monitor of a ATM, even record the displayed data by video cameras to steal important security information. That is the reason why viewing angles of monitors of most ATMs are narrowed, so as to decrease a risk of data peeking. Thus, security of displayed data is important in daily life.

Besides, as technology advances, the user pursues not only high quality image, but also three-dimensional (3-D) and more realistic images. Currently, the 3-D image display technique requires a display device to cooperate with glasses, e.g. a pair of shutter glasses, the main principle of 3-D image display technique is to make the left eye and the right eye see different image frames, respectively, such that the human brain regards the different image frames viewed by the two eyes as a 3-D image.

Shutter Glasses are widely offered to users for viewing 3-D image displayed by the display device, the shutter glasses have a pair of shutter lenses, each shutter lens is switched back and forth between an on state and an off state continuously. For example, when the shutter lens corresponding to the left eye is switched on at some certain time, the shutter lens corresponding to the right eye is switched off, whereas the shutter lens corresponding to the right eye is switched on at another certain time, the shutter lens corresponding to the left eye is switched off. For example, please refer to FIG. 1, which is a schematic diagram of operations of a conventional 3-D image system 10. The display device 100 has a function of frame rate scanning, and outputs the image with a frame rate which is faster than a normal output speed (e.g. twice frequency, 120 Hz), so that the frames L1, R1 . . . Ln, Rn of the left eye and the right eye are outputted in turn. The shutter glasses 102 achieves time sequence synchronization with the display device 100 through wired or wireless transmission, such that the left and right shutter lenses are properly switched to the on state and the off state, and thus the two eyes see different frames, e.g. the right shutter lens sees a frame R1, and the left shutter lens sees a frame L1, so as to achieve the 3-D visual effect.

Therefore, the present invention utilizes 3-D image display technique to achieve the requirement of display data security. As a result, security data may be displayed in public without peeking by surrounding people.

### SUMMARY OF THE INVENTION

It is therefore an object of the present invention to provide a method for data security and device thereof for improving safety of security data.

A method for data security for shutter glasses is disclosed. The method includes receiving a frame data outputted from a display device, wherein the frame data includes a security data arranged in the frame data according to an encoding rule, and switching back and forth between an on state and an off state according to the encoding rule, to retrieve the security data from the frame data.

A method of data security for a display device for outputting a frame data to shutter glasses is disclosed. The method includes arranging a security data in the frame data according to an encoding rule, and performing a synchronization procedure with the shutter glasses, such that the shutter glasses switches back and forth between an on state and an off state according to the encoding rule, so as to retrieve the security data from the frame data.

A display device with a function of data security is disclosed. The display device is used for outputting a frame data to shutter glasses and includes an encoding unit, for arranging a security data in the frame data according to an encoding rule, and a synchronization unit, coupled to the encoding unit, for performing a synchronization procedure with the shutter glasses, such that the shutter glasses are switched back and forth between the on state and the off state according to the encoding rule, so as to retrieve the security data from the frame data.

A pair of shutter glasses with a function of data security is disclosed. The shutter glasses includes a shutter lens, for receiving a frame data from a display device, wherein the frame data includes a security data arranged by the display device according to an encoding rule, and a control unit, coupled to the receiving unit, for switching the shutter glasses back and forth between an on state and an off state according to the encoding rule, so as to retrieve the security data from the frame data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of operations of a conventional 3-D image system.

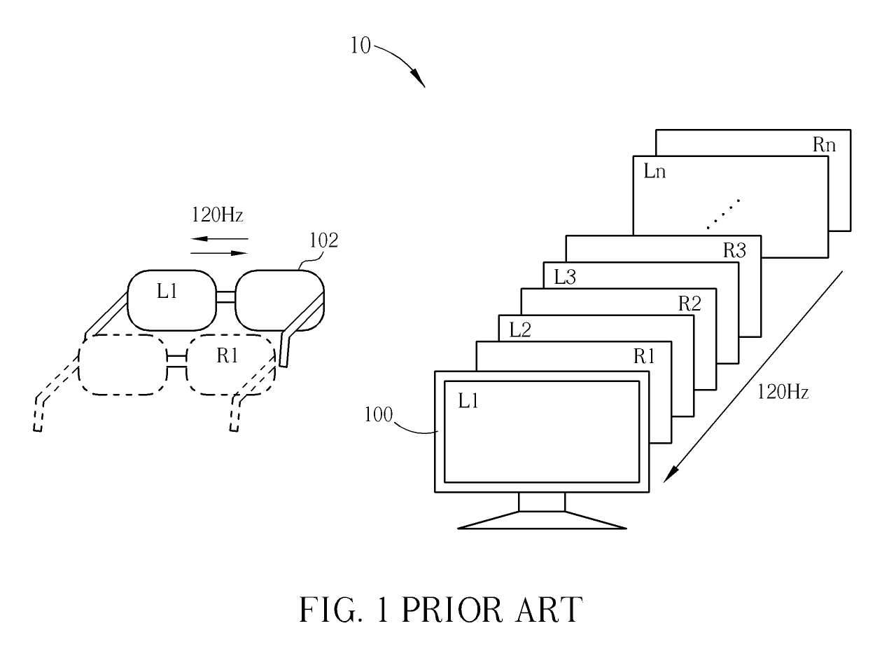

FIG. 2 is a schematic diagram of an image system according to an embodiment of the present invention.

FIG. 3 is a functional block diagram of the image system and the shutter glasses shown in FIG. 2.

FIG. 4 is a data security process according to an embodiment of the present invention.

FIG. 5 is a schematic diagram of an encoding rule according to the embodiment of the present invention.

FIG. 6 is a schematic diagram of a synchronous time sequence.

### DETAILED DESCRIPTION

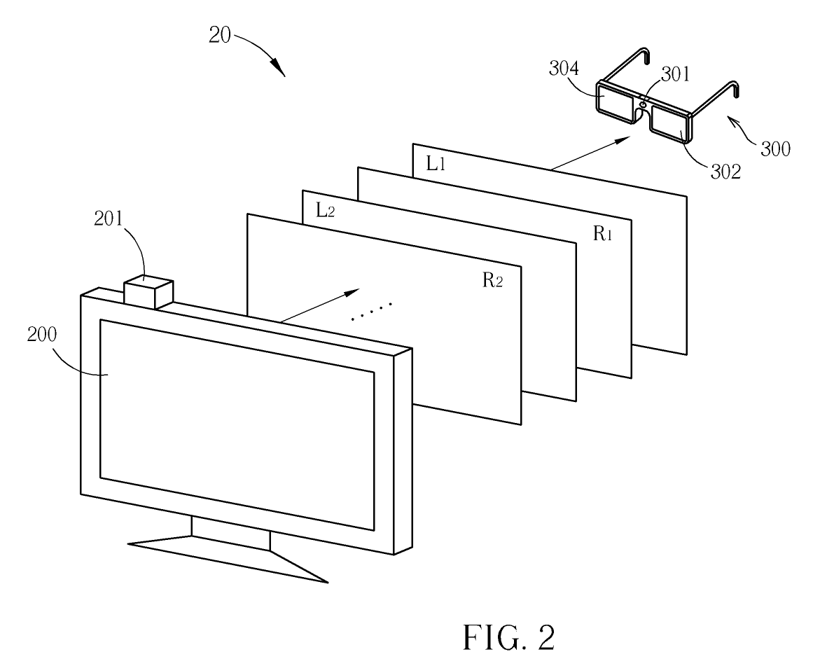

Please refer to FIG. 2, which is a schematic diagram of an image system 20 according to an embodiment of the present invention. The image system 20 includes a display device 200 and shutter glasses 300. The display device 200 may be a liquid crystal display (LCD), organic light-emitting diode (OLED) display, plasma display, digital light processing (DLP) display, liquid crystal on silicon (LCoS) display and so on. The display device 200 utilizes frame rate scanning function, i.e. a frame fresh rate of the display device 200 is faster than a normal outputting speed (frequency) of an image, so as to output frame data R₁, L₂, R₂ . . . Lₙ, Rₙ, Lₙ of left eye and right eyes in turns. Besides, the display device 200 includes a synchronization signal transmitter 201 for transmitting a synchronization signal. The shutter glasses 300 are provided for users to wear and retrieve a security data in the frame data L₁-Rₙ of the display device 200. The shutter glasses 300 include a left lens 302, a right lens 304 and a synchronization signal receiver 301 for receiving the synchronization signal transmitted from the display device 200, wherein the left lens 302 and the right lens 304 are made of liquid crystal glasses. In the embodiment of the present invention, the shutter lens of the shutter glasses may be liquid crystal glasses, and the shutter lens is switched to anon state and an off state through the control of liquid crystal layers. In general, the shutter lens is at the on state and allows the light passes through when no voltage is applied on the liquid crystal layer; the shutter lens is at the off state and blocks the light when a voltage is applied on the liquid crystal layer. 3-D image display technique should be well known by those skilled in the art, and herein is omitted.

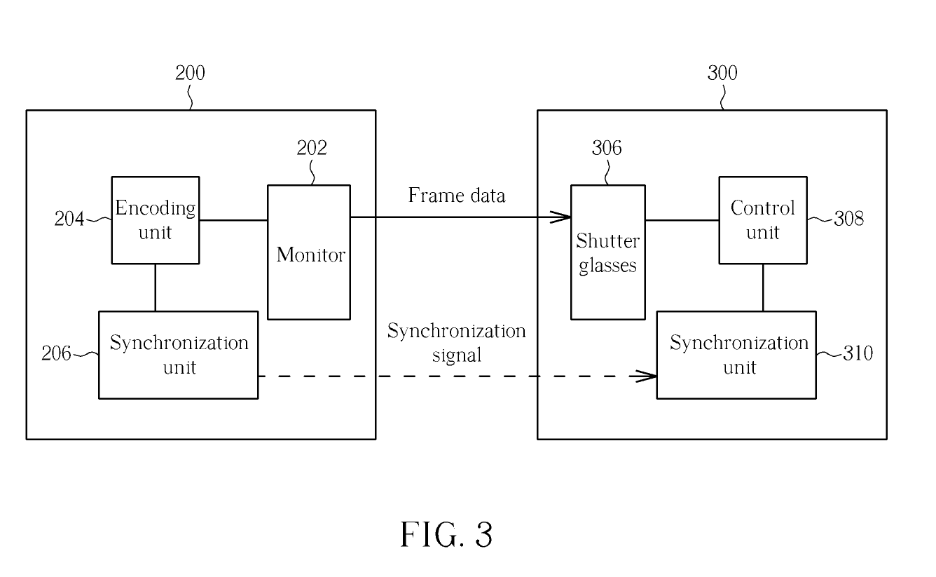

Please refer to FIG. 3, which is a functional block diagram of the display device 200 and the shutter glasses 300 shown in FIG. 2. The display device 200 includes a monitor 202, an encoding unit 204 and a synchronization unit 206. The shutter glasses 300 include a shutter lens 306, a control unit 308 and a synchronization unit 310. The encoding unit 204 of the display device 200 arranges the security data in the frame data L₁-Rₙ according to an encoding rule, and outputs the frame data L₁-Rₙ via the monitor 202. The synchronization unit 206, e.g. the synchronization signal transmitter 201 shown in FIG. 2, performs a synchronization procedure between the display device 200 and the shutter glasses 300, the synchronization unit 206 transmits the synchronization signal to the shutter glasses 300 to align a synchronization time sequence datum point of the shutter glasses 300. On the other hand, the synchronization unit 310 of the shutter glasses 300, e.g. the synchronization signal receiver 301 shown in FIG. 2, receives the synchronization signal transmitted from the synchronization unit 206, and aligns the synchronized time sequence datum point of the display device 200 according to the synchronization signal. The control unit 308 controls the on/off states of the shutter lens 306, i.e. on/off states of the left lens 302 and the right lens 304, according to the encoding rule used by the encoding unit 204.

Noticeably, the embodiment of the present invention realizes the control unit 308 via a synchronization procedure according to the encoding rule to control the on/off states of the shutter lens 306. When the shutter glasses 300 and the display device 200 are synchronized, the shutter glasses 300 and the display device 200 have a same time sequence, and thus the control unit 308 is able to acquire output time sequences of each frame data L₁-Rₙ of the monitor 202. Besides, the synchronization signal not only includes information of the synchronized time sequence datum point, but also information related to the encoding rule, so that the shutter glasses 300 acquires the encoding rule used by the display device 200, i.e. arrangement rule of the security data in the frame data L₁-Rₙ, once the synchronization signal is received. Therefore, the control unit 308 switches the shutter lens 306 to the on state correctly according to the output time sequences of the frame data L₁-Rₙ and the arrangement rule of the security data in the frame data L₁-Rₙ, so as to retrieve the security data. On the other hand, a list of encoding rule may be stored in the control unit 308 and the encoding unit 204 of present invention, so as to access the information of the encoding rule fast.

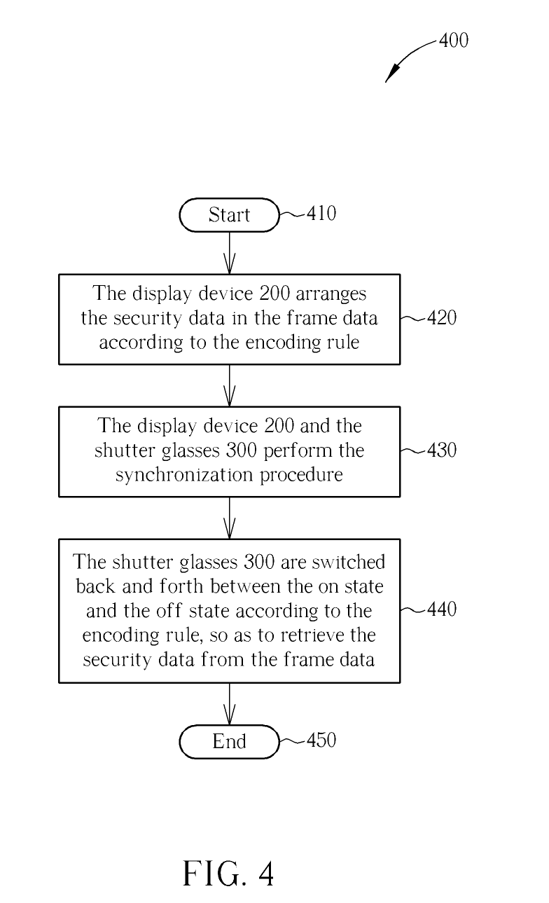

Please refer to FIG. 4, operations about the image system 20 can be summarized into a data security process 400. As shown in FIG. 4, the data security process 400 includes the following steps:

Step 410: Start.

Step 420: The display device 200 arranges the security data in the frame data according to the encoding rule.

Step 430: The display device 200 and the shutter glasses 300 perform the synchronization procedure.

Step 440: The shutter glasses 300 are switched back and forth between the on state and the off state according to the encoding rule, so as to retrieve the security data from the frame data.

Step 450: End.

According to the process 40, the display device 200 arranges the security data on the frame data desired to be displayed according to the encoding rule, and the shutter glasses 300 acquire the output rule and the output time sequence of the security data according to the encoding rule and synchronization character of the display device 200, so as to control the shutter lens 306 being switched on/off to retrieve the security data. Operations for realizing the process 400 can be obtained by referring to above description.

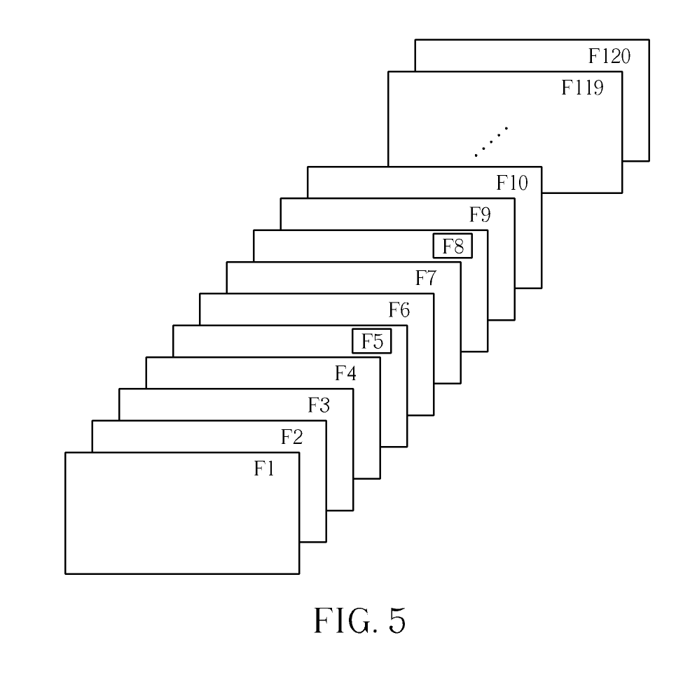

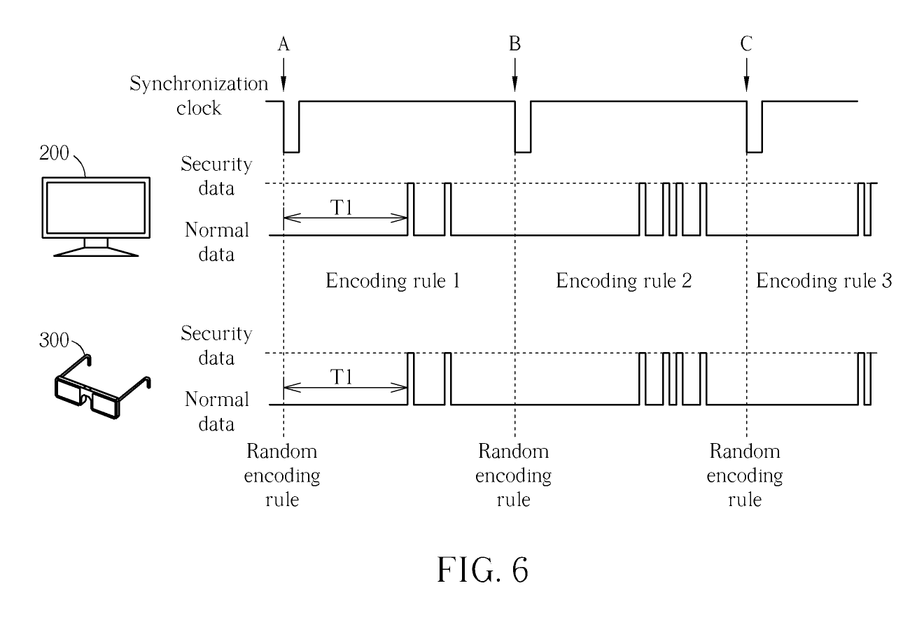

The following example is to illustrate the characteristics of the present invention clearly. Please refer to FIG. 5, which is a schematic diagram of the encoding rule according to the embodiment of the present invention. Assume the frame rate of the display device 200 is 120 Hz, i.e. the display device 200 outputs 120 frame data per second. As shown in FIG. 5, the display device 200 arranges the security data in the frame data F5, F8 of the frame data F1, F2, . . . , F120 according to the encoding rule. Furthermore, please refer to FIG. 6, which is a time diagram of the display device 200 and the shutter glasses 300. The display device 200 and the shutter glasses 300 perform synchronization via wired or wireless transmission. Taking wireless transmission for example, the display device 200 may utilize wireless techniques, such as infrared (IR), wireless fidelity (WIFI), blue tooth (BT) or radio frequency (RF), to transmit the synchronization signal, so as to align the time sequence datum points of display device 200 and the shutter glasses 300. As mentioned above, the synchronization signal may include information of time datum point and the encoding rule, so that the shutter glasses 300 is able to acquire the output rule and the output sequence of the security signal between the normal signal, e.g. the display device 200 outputs the frame data F5 at a time T1 shown in FIG. 6, and thus switch the shutter glasses on to retrieve the security data when the security signal is outputted.

Noticeably, the encoding rule may be a fixed encoding rule, i.e. arrangement order of the security data is fixed in the frame data F5, F8, which means the display device 200 uses the same encoding rule on each time datum point. Or, the encoding rule may be a random encoding rule, i.e. the security data may be arranged in the frame data F2, F4, F6, and thus the display device 200 may select different encoding rules on any time datum point. As shown in FIG. 6, the display device 200 or the shutter glasses 300 use an encoding rule 1 at a time datum point A; reselect an encoding rule 2 at a time datum point B and so on.

To sum up, the present invention provides the method of data security and the device thereof, only the shutter glasses has the same synchronized time sequence and the same encoding rule of the display device is able to retrieve the security data. Therefore, the user without the specific shutter glasses is unable to retrieve the security data but the normal displayed frame data.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for data security, for shutter glasses, the method comprising:
receiving a frame data outputted from a display device, wherein the frame data includes a security data arranged in the frame data according to an encoding rule; and
switching back and forth between an on state and an off state according to the encoding rule, to retrieve the security data from the frame data.

2. The method of claim 1, wherein the step of switching back and forth between an on state and an off state to retrieve the security data from the frame data comprises:
performing a synchronization procedure with the display device to switch to the on state according to the encoding rule when the security data is outputted.

3. The method of claim 2, wherein the step of performing a synchronization procedure of the display device comprising:
receiving a synchronization signal transmitted from the display device to align a synchronization time sequence datum point of the display device.

4. A method of data security, for a display device for outputting a frame data to shutter glasses, the method comprising:
arranging a security data in the frame data according to an encoding rule; and
performing a synchronization procedure with the shutter glasses, such that the shutter glasses switches back and forth between an on state and an off state according to the encoding rule, so as to retrieve the security data from the frame data.

5. The method of claim 4, wherein the step of performing a synchronization procedure with the shutter glasses comprising:
transmitting a synchronization signal to the shutter glasses to calibrate a synchronized time sequence datum point of the shutter glasses.

6. The method of claim 4, further comprising:
rearranging the security data in the frame data according to a second encoding rule; and
performing the synchronization procedure with the shutter glasses, such that the shutter glasses switches back and forth between the on state and the off state according to the second encoding rule, so as to retrieve the security data from the frame data.

7. A display device with a function of data security, the display device is used for outputting a frame data to shutter glasses, the display device comprising:
an encoding unit, for arranging a security data in the frame data according to an encoding rule; and
a synchronization unit, coupled to the encoding unit, for performing a synchronization procedure with the shutter glasses, such that the shutter glasses are switched back and forth between the on state and the off state according to the encoding rule, so as to retrieve the security data from the frame data.

8. The display device of claim 7, wherein the synchronization unit is further used for transmitting a synchronization signal to the shutter glasses, to align a synchronization time sequence datum point of the shutter glasses.

9. The display device of claim 7, wherein the encoding unit is further used for rearranging the security data in the frame data according to a second encoding rule.

10. A pair of shutter glasses with a function of data security, the shutter glasses comprising:
a shutter lens, for receiving a frame data from a display device, wherein the frame data includes a security data arranged by the display device according to an encoding rule; and
a control unit, coupled to the receiving unit, for switching the shutter glasses back and forth between an on state and an off state according to the encoding rule, so as to retrieve the security data from the frame data.

11. The shutter glasses of claim 10, further comprising:
a synchronization unit, coupled to the control unit, for performing a synchronization procedure with the display device, such that the control unit switches to the on state according to the encoding rule when the security data is outputted.

12. The shutter glasses of claim 11, wherein the synchronization unit is further used for receiving a synchronization signal transmitted from the display device to align a synchronization time sequence datum point of the display device.
